(19) United States
(12) Patent Application Publication
(10) Pub. No.: US 2026/0196246 A1
(43) Pub. Date: Jul. 9, 2026

(54) Electronic Devices and Corresponding Methods for Excluding Picture-in-Picture Content from Screenshots and Screen Recordings

(71) Applicant: Motorola Mobility LLC, Chicago, IL (US)

(72) Inventors: Amit Kumar Agrawal, Bangalore (IN); Ganesh Pradeep P V, Bangalore (IN); Sinchana A P, Bangalore (IN)

(21) Appl. No.: 19/010,123

(22) Filed: Jan. 5, 2025

(51) Int. Cl. G11B 27/031; G06T 11/60

(52) U.S. Cl. CPC G11B 27/031; G06T 11/60; G06T 2200/24

(57) ABSTRACT

A method and electronic device manage screenshots and screen recordings by precluding picture-in-picture (PIP) content. The method involves receiving user input initiating a screenshot operation while visual content is presented. One or more processors determine if PIP content is present and assess the relevance of the PIP content to the primary visual content. If deemed irrelevant, the processors preclude the depiction of the PIP content in the resulting screenshot or screen recording. This ensures that only the intended visual content is captured, enhancing privacy and clarity. The method can also omit audio associated with the PIP content. The electronic device includes a user interface, and processors configured to perform these operations, providing a seamless and automated solution for users.

### BACKGROUND

### Technical Field

This disclosure relates generally to electronic devices having user interfaces, and more particularly to electronic devices having screenshot capabilities.

### Background Art

Capturing and sharing visual information quickly using electronic devices such as smartphones has become important for users. “Screenshot” capabilities are frequently used in communication to illustrate points or highlight information. Indeed, captured screenshots are often shared via email, messaging applications, or collaborative platforms.

Issues can arise when capturing screenshots in the presence of smaller windows that allow users to multitask by keeping a smaller window open on top of their primary application poses significant challenges. It would be advantageous to have improved electronic devices and corresponding methods addressing these challenges.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates another explanatory method in accordance with one or more embodiments of the disclosure.

FIG. 4 illustrates one or more embodiments of the disclosure.

FIG. 5 illustrates a situation that can arise in the absence of the benefit of embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, by a user interface while visual content is being presented the user interface, user input initiating a screenshot operation, determining, by one or more processors operable with the user interface, whether picture-in-picture content is being presented with the visual content and, where the picture-in-picture content is being presented with the visual content, determining, by the one or more processors, whether the picture-in-picture content is relevant to other portions of the visual content, and where the picture-in-picture content is irrelevant to the other portions of the visual content, precluding, by the one or more processors, depiction of the picture-in-picture content from a screenshot resulting from the screenshot operation. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to receipt of user input by the user interface initiating a screenshot operation while visual content is being presented on the user interface with picture-in-picture content overlayed atop the visual content, precluding depiction of picture-in-picture content in one or more screenshots resulting from the screenshot operation by instead depicting portions of the visual content beneath which the picture-in-picture content is overlayed at locations where the picture-in-picture content is overlayed as described herein. The non-processor circuits may include, but are not limited to, a radio receiver, a radio transmitter, signal drivers, clock circuits, power source circuits, and user input devices.

As such, these functions may be interpreted as steps of a method to perform presenting, by a user interface, visual content on a display of the electronic device and also presenting, by the user interface, picture-in-picture content atop the visual content. In one or more embodiments, the method comprises receiving, by the user interface, user input requesting screenshot capture of an area of the display spanning both the visual content and the picture-in-picture content. In one or more embodiments, the method comprises precluding, by one or more processors operable with the user interface, depictions of the picture-in-picture content from screenshots resulting from the screenshot capture when the picture-in-picture content is unrelated to the visual content.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, capturing and sharing visual information quickly via screenshot capture is widely used. Users rely on screenshot tools to convey visual information efficiently, enhancing their ability to communicate and collaborate.

Embodiments of the disclosure contemplate that issues can arise when capturing screenshots in the presence of smaller windows that allow users to multitask by keeping a smaller window open on top of their primary application. This smaller window, often referred to as picture-in-picture (PIP), can overlay the primary content, leading to unintended inclusion of the PIP content in the screenshot.

This can result in privacy concerns, as the PIP content may contain sensitive or irrelevant information that the user does not wish to share. Additionally, the presence of PIP content can clutter the screenshot, detracting from the clarity and focus of the primary content.

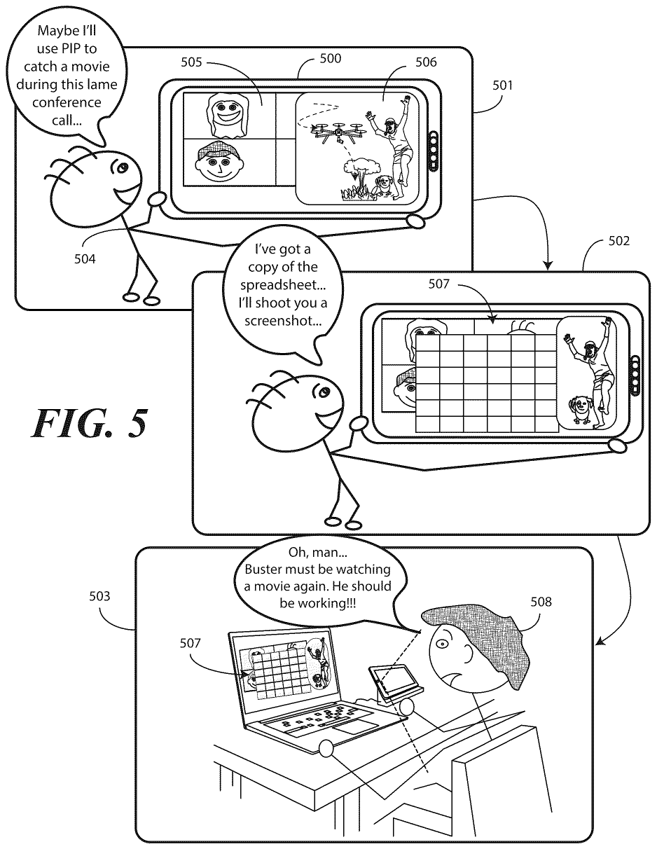

To illustrate how this can occur, turn first to FIG. 5. Beginning at step 501, a user 504 of an electronic device 500, whose name is Buster, decides to watch a movie 506 using a picture-in-picture feature of the electronic device 500 during a business videoconference 505.

At step 501, user 504 may find the videoconference 505 unengaging for several reasons. The videoconference 505 could involve repetitive discussions, lack of interactive elements, or topics that do not pertain to user 504's interests or responsibilities. Additionally, the videoconference 505 may feature lengthy presentations with minimal participant engagement, leading to a monotonous experience.

For these reasons, user 504 may find the movie 506 to be more captivating due to the dynamic and thrilling plotline. In this illustrative example, the movie 506 features an exhilarating story where a young girl and her loyal dog face an army of invading drones. The plot unfolds as the girl discovers a hidden talent for hacking, which she uses to disrupt the drones'communication systems. Together with her dog, who has been trained to detect and disable the drones, they embark on a mission to protect their town from the relentless invasion.

Accordingly, during the videoconference 505 the movie 506 keeps user 504 on the edge of their seat with high-stakes action sequences, clever strategies, and the heartwarming bond between the girl and her dog. This stark contrast between the engaging movie 506 and the mundane videoconference 505 explains why user 504 would prefer to utilize the picture-in-picture feature of the electronic device 500 to watch the movie 506 during the videoconference 505.

Thus, at step 501, user 504 utilizes the picture-in-picture feature of the electronic device 500 to watch the movie 506 during the videoconference 505. Despite the engaging and dynamic plotline of the movie 506, user 504 remains attentive to the videoconference 505. The picture-in-picture feature allows user 504 to monitor the videoconference 505 while simultaneously enjoying the movie 506. This dual engagement ensures that user 504 does not miss any information or discussions relevant to their responsibilities.

In this illustrative embodiment, at step 501 during the videoconference 505, one of the participants mentions a spreadsheet that user 504 created. The mention of the spreadsheet immediately captures user 504's attention, prompting them to shift focus from the movie 506 to the videoconference 505.

At step 502, user 504 quickly pulls up the spreadsheet 507 and informs the videoconference participants of the willingness to share the spreadsheet via screenshot. User 504 may exhibit eagerness to share the spreadsheet due to the pride in the meticulous work and the desire to ensure that the correct version of the document is presented. By taking the initiative, user 504 can control the narrative and highlight specific data points or visual elements that may be significant for the discussion. This proactive approach also demonstrates user 504's engagement and readiness to contribute to the meeting, potentially enhancing their professional reputation among peers.

User 504 elects to share the spreadsheet via screenshot rather than through email or other conduits because this technique is quick and offers several advantages. Illustrating by example, screenshots provide an immediate and visual representation of the content, allowing participants to view the spreadsheet in real-time without the need to open additional applications or files. Screenshots also eliminate the delays associated with composing and sending an email, waiting for recipients to receive and open the attachment, and ensuring compatibility across different email clients and software versions. Screenshots can be captured and shared almost instantaneously, facilitating a smoother and more efficient flow of information during the videoconference. This immediacy ensures that the discussion remains focused and that all participants are on the same page, literally and figuratively, enhancing the overall productivity of the meeting.

Thus, at step 502 user 504, while engaged in the videoconference 505, decides to share the spreadsheet 507 via a screenshot. User 504, in the midst of the discussion, quickly captures the screenshot without considering the presence of the picture-in-picture (PIP) window displaying the epic movie 506. The PIP window, which overlays the primary content, inadvertently becomes part of the screenshot. This oversight results in the inclusion of the movie 506 within the captured image, which user 504 intended to share with the videoconference participants.

The presence of the movie 506 in the screenshot introduces several issues. First, the inclusion of the PIP content may lead to privacy concerns, as the movie 506 could contain sensitive or irrelevant information that user 504 does not wish to share with the videoconference participants. Secondly, the PIP content can clutter the screenshot, detracting from the clarity and focus of the primary content, which is the spreadsheet 507. This unintended inclusion of the movie 506 can cause confusion among the participants and may require user 504 to manually edit the screenshot to remove the PIP content, a process that is time-consuming and prone to errors.

At step 503 of FIG. 5, after user 504 shares the screenshot of the spreadsheet 507, user 508 notices the presence of the movie 506 in the picture-in-picture (PIP) window. User 508 begins to perceive user 504 as a derelict, suspecting that user 504 is not fully engaged in the videoconference 505 and is instead watching a movie.

This perception can lead to several adverse consequences for user 504. First, user 508 may question user 504's professionalism and commitment to their work responsibilities. This doubt can erode trust and confidence in user 504's ability to perform tasks diligently. User 508 may also share this observation with other colleagues or superiors, potentially damaging user 504's reputation within the organization.

Second, user 504 may face disciplinary actions from management. The inclusion of the movie 506 in the screenshot serves as evidence of user 504's divided attention during a work meeting. Management may interpret this as a lack of focus and dedication, leading to formal reprimands, reduced responsibilities, or even termination of employment in severe cases.

Additionally, user 504's career progression may be adversely affected. Opportunities for promotions, raises, or participation in important projects may diminish as a result of the perceived lack of professionalism. Colleagues and superiors may become hesitant to rely on user 504 for tasks, fearing that user 504's attention may be compromised by non-work-related activities. Thus, as shown in FIG. 5 the inadvertent inclusion of the movie 506 in the screenshot shared by user 504 can lead to significant negative repercussions, including damaged reputation, disciplinary actions, and hindered career advancement.

Existing solutions for managing screenshots and screen recordings do not adequately address the challenges posed by PIP content. Current methods may require manual editing to remove or obscure the PIP content, which can be time-consuming and prone to errors.

Furthermore, these methods do not provide a seamless and automated way to ensure that only the desired content is captured, leading to potential privacy breaches and reduced user satisfaction. The potential consequences noted above in the description of FIG. 5 underscore the importance of managing and precluding PIP content in screenshots and screen recordings to maintain professional integrity and focus during work-related activities.

Advantageously, embodiments of the disclosure aim to resolve these issues by providing an advanced approach to managing screenshots and screen recordings. In one or more embodiments, a method involves determining whether PIP content is present and, if so, assessing the relevance of the PIP content to the primary content. If the PIP content is deemed irrelevant, the method precludes the depiction of the PIP content in the resulting screenshot or screen recording. This ensures that only the intended content is captured, enhancing privacy and improving the overall user experience. In one or more embodiments, the method can be implemented using one or more processors operable with a user interface, providing a seamless and automated solution for users.

In one or more embodiments, a method in an electronic device that involves receiving user input through a user interface while visual content is being presented. In one or more embodiments, the user input initiates a screenshot operation.

In one or more embodiments, the method includes determining, by one or more processors operable with the user interface, whether picture-in-picture (PIP) content is being presented with the visual content. In one or more embodiments, if the PIP content is being presented, the method further involves determining whether the PIP content is relevant to other portions of the visual content.

In one or more embodiments, if the PIP content is deemed irrelevant to the other portions of the visual content, the method precludes the depiction of the PIP content from the screenshot resulting from the screenshot operation. Advantageously, the method ensures that the screenshot captures only the intended visual content, excluding any irrelevant PIP content that may overlay the primary content.

In one or more embodiments, this process involves querying the display manager to identify the type and relevancy of the contents being rendered on the device's display. The determination of relevancy can be based on various factors, including the context of the visual content and the nature of the PIP content.

By precluding the depiction of irrelevant PIP content, the method addresses privacy concerns and enhances the clarity and focus of the captured screenshot. The method can be implemented using one or more processors that work in conjunction with the user interface to perform the necessary determinations and preclusions. This implementation can be configured as part of the screenshot settings, allowing users to customize their screenshot capture preferences. The method provides a seamless and automated solution for managing screenshots, ensuring that only the desired content is captured and shared, thereby improving the overall user experience.

In one or more embodiments, a method manages screenshots and screen recordings by precluding picture-in-picture (PIP) freeform window content. In an electronic device, the method begins by determining that a visual or audio/visual content is being triggered to capture via a screenshot or screen record operation in one or more embodiments. In one or more embodiments, the display manager is queried to determine the type and relevancy of the contents being rendered on the device's display.

In one or more embodiments, the method then identifies if there is an overlay content being rendered on top of the current foreground application in a PIP format. Upon identifying the PIP content, the method captures the visual or audio/visual content while precluding the contents rendered by the PIP window. This preclusion can be configured as part of the screenshot or screen record settings.

Optionally, artificial intelligence (AI)-based image analysis techniques can categorize the foreground and PIP content to determine their relevancy. During the screenshot or screen record operation, the original content of the device display can be captured as provided by the foreground activity, excluding the PIP window format and replacing the PIP window portion with the original application display content.

In the case of screen recording, the method can also preclude audio data from the PIP window. If multiple applications provide audio output, only the audio from the PIP window is precluded by the audio manager. In some embodiments, this method ensures that secure content playback results in the screenshot or screen record containing black boxes without any relevant content. This approach addresses privacy concerns and enhances the clarity and focus of the captured content, providing a seamless and automated solution for users

In one or more embodiments, an electronic device comprises a user interface and one or more processors operable with the user interface. In one or more embodiments, the one or more processors are configured to, in response to receipt of user input by the user interface initiating a screenshot operation while visual content is being presented on the user interface with picture-in-picture content overlayed atop the visual content, preclude depiction of the picture-in-picture content in one or more screenshots resulting from the screenshot operation by instead depicting portions of the visual content beneath which the picture-in-picture content is overlayed at locations where the picture-in-picture content is overlayed.

In one or more embodiments, the one or more processors are further configured to omit audio content associated with the picture-in-picture content from inclusion with the one or more screenshots. The one or more processors sometimes only preclude depiction of the picture-in-picture content in one or more screenshots when the picture-in-picture content is unrelated to the visual content.

In one or more embodiments, the one or more processors deem the picture-in-picture content to be unrelated to the visual content when other user input received by the user interface defines a boundary around the picture-in-picture content. In one or more embodiments, the visual content comprises a videoconference and the picture-in-picture content comprises a movie.

Advantageously, this configuration ensures that when a user takes a screenshot, any PIP content that may contain sensitive or irrelevant information is excluded from the screenshot. Instead, the screenshot will display the underlying visual content, maintaining the clarity and focus of the primary content.

Advantageously, this arrangement addresses privacy concerns by preventing unintended sharing of PIP content, which could include personal or confidential information. Additionally, it enhances the user experience by providing a cleaner and more relevant screenshot, free from distractions caused by overlayed PIP content. This method is particularly useful in professional settings where users may need to share screenshots during presentations or meetings without revealing unrelated or private content.

in one or more embodiments, a method in an electronic device involves presenting visual content on a display through a user interface. The method also includes presenting picture-in-picture (PIP) content atop the visual content.

In one or more embodiments, the user interface receives user input requesting screenshot capture of an area of the display that spans both the visual content and the PIP content. The method further involves precluding depictions of the PIP content from screenshots resulting from the screenshot capture when the PIP content is unrelated to the visual content.

The determination of whether the PIP content is unrelated to the visual content can be based on various factors, including the presence of audio associated with the PIP content. If the PIP content has audio associated with the PIP content, the method deems the PIP content to be unrelated to the visual content.

Advantageously, this ensures that the screenshot captures only the intended visual content, excluding any irrelevant PIP content that may overlay the primary content. The method can replace the PIP content with portions of the visual content over which the PIP content is positioned. This approach maintains the clarity and focus of the primary content, addressing privacy concerns and enhancing the overall user experience. The method provides a seamless and automated solution for managing screenshots, ensuring that only the desired content is captured and shared. Other advantages offered by embodiments of the disclosure will be described below. Still others will be obvious to those of ordinary skill in the art having the benefit of this disclosure.

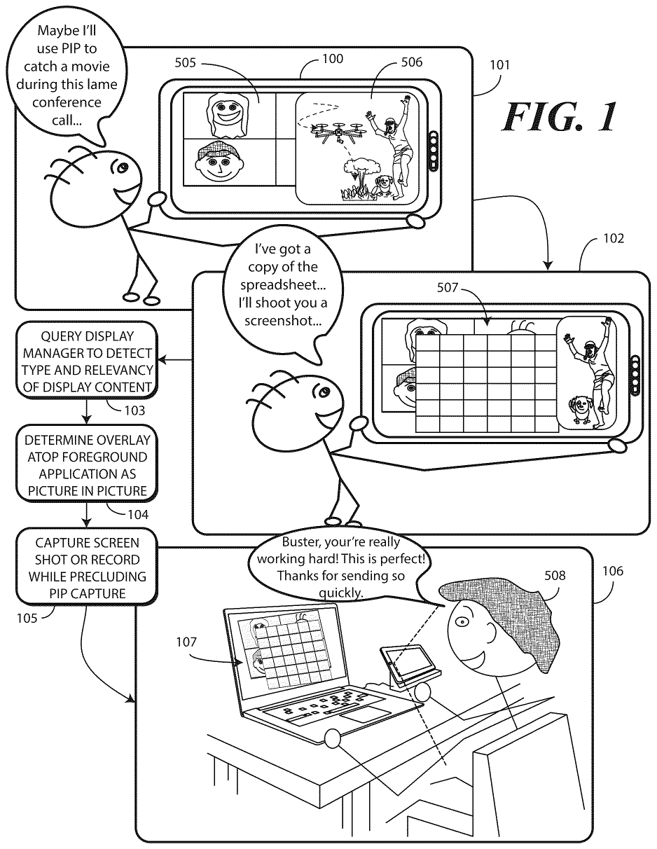

Turning now to FIG. 1, illustrated therein are one or more method steps in accordance with one or more embodiments of the disclosure. At step 101 of FIG. 1, our friend, Buster, is again sneakily watching a movie 506 using the picture-in-picture feature of his electronic device 100 during the boring videoconference 505. However, in contrast to FIG. 5, at step 101 the electronic device 100 is configured in accordance with embodiments of the disclosure. Advantageously, this allows one or more processors of the electronic device 100 to detect the presence of the picture-in-picture (PIP) content (the movie 506) overlaying the primary visual content of the videoconference 505.

The device's processors therefore determine that the PIP content, which in this case is the movie 506, is unrelated to the primary content of the videoconference 505. Upon receiving user input to capture a screenshot, the electronic device 100 precludes the depiction of the PIP content from the resulting screenshot. Instead, the processors replace the PIP content with the underlying visual content of the videoconference, ensuring that the screenshot only includes the relevant information from the videoconference 505.

Beneficially, these method steps address privacy concerns by preventing the unintended sharing of the movie 506, which could contain sensitive or irrelevant information. Additionally, in one or more embodiments the electronic device 100 omits any audio associated with the PIP content from being included in the screenshot or screen recording. This ensures that the audio from the movie 506 does not interfere with the audio of the videoconference 505, maintaining the clarity and focus of the primary content. By providing a seamless and automated solution for managing screenshots and screen recordings, the electronic device 100 enhances the overall user experience, allowing Buster to multitask without compromising the integrity of the shared content.

Accordingly, when Buster elects to share the spreadsheet 507 via screenshot at step 102, rather than sharing the movie 506 as well, at step 103 the one or more processors of electronic device 100 query the display manger to determine the type and relevancy of the contents being rendered on the display of the electronic device 100. At step 104, the one or more processors determine that there is overlay content, in the form of the movie 506, being overlaid at least partially on top of the current foreground application, which is the application presenting the spreadsheet 507.

In one or more embodiments, step 104 comprises determining that the overlay content is PIP content. In one or more embodiments, step 104 involves using AI-based image analysis techniques to categorize the foreground and PIP content. For example, the AI can analyze the visual elements of the foreground application and the PIP window to determine their contextual relevance. If the AI identifies that the PIP content is unrelated to the primary content, the method precludes the depiction of the PIP content in the resulting screenshot or screen recording.

At step 105, the one or more processors of the electronic device 100 capture the content being presented on the display via screenshot and preclude the PIP window contents from being rendered. Step 105 can optionally include other operations as well.

Illustrating by example, in one or more embodiments step 105 configures the preclusion of PIP window contents during screenshot or screen record operations as part of the screenshot or screen record settings. For instance, users can access the settings menu of the electronic device and enable an option to automatically exclude PIP content from captures. This configuration ensures that the device consistently applies the preclusion method whenever a screenshot or screen recording is initiated.

In one or more embodiments, step 105 involves capturing the original content of the device display as provided by the foreground activity, excluding the PIP window format and replacing the PIP window portion with the original application display content. For example, if a user is recording a video of a presentation while a PIP window displays a video call, in one or more embodiments step 105 replaces the PIP window area with the presentation content, ensuring a seamless and uninterrupted recording of the primary activity.

In one or more embodiments, step 105 also precludes audio data from the PIP window during screen recording. If multiple applications provide audio output, this step 105 ensures that only the audio from the PIP window is excluded by the audio manager. For instance, if a user is recording a tutorial while a PIP window plays music, the method captures the tutorial's audio while excluding the music from the PIP window, maintaining the focus on the tutorial content.

In one or more embodiments, step 105 addresses secure content playback by ensuring that the screenshot or screen record contains black boxes without any relevant content. For example, if the PIP window displays a DRM-protected video, the method replaces the PIP window area with a black box, preventing the capture of protected content and adhering to content protection regulations. This approach enhances privacy and security while maintaining the integrity of the captured content.

At step 106 of FIG. 1, since Buster has used an electronic device 100 configured in accordance with embodiments of the disclosure to capture and share a screenshot of the spreadsheet 107 during the videoconference 505, the spreadsheet 107 appears cleanly and pristinely on the recipient's devices despite the fact that an amazingly good movie was being presented on the electronic device 100 partially atop the spreadsheet 107 when the screenshot was captured. Indeed, the one or more processors of the electronic device 100 have detect the presence of picture-in-picture (PIP) content overlaying the primary visual content. Recognizing that the PIP content is unrelated to the primary content, the one or more processors of the electronic device 100 precludes the depiction of the PIP content from the resulting screenshot.

This ensures that the screenshot only includes the relevant information from the videoconference, maintaining the clarity and focus of the primary content. Upon receiving the screenshot, user 508, impressed by the promptness and professionalism of Buster's response, exclaims, “Buster! You're really working hard! This is excellent! Thanks for sending so quickly.” This acknowledgment highlights Buster's dedication and efficiency, reinforcing his reputation as a diligent and reliable team member, thanks to utilizing an electronic device 100 configured in accordance with one or more embodiments of the disclosure.

The seamless and automated solution provided by the electronic device 100 allows Buster to multitask effectively without compromising the integrity of the shared content. As word of Buster's diligence spreads throughout the organization, he receives numerous accolades from colleagues and superiors. Recognizing his commitment and hard work, the management decides to honor Buster with a lavish dinner. The event features copious amounts of Gewurztraminer, a fragrant and aromatic wine, paired with spicy fried Thai tofu. The dinner serves as a testament to the multitude of benefits offered by embodiments of the disclosure, each of which Buster uses to underscore his contributions, thereby leading to the high regard in which he is held by his peers.

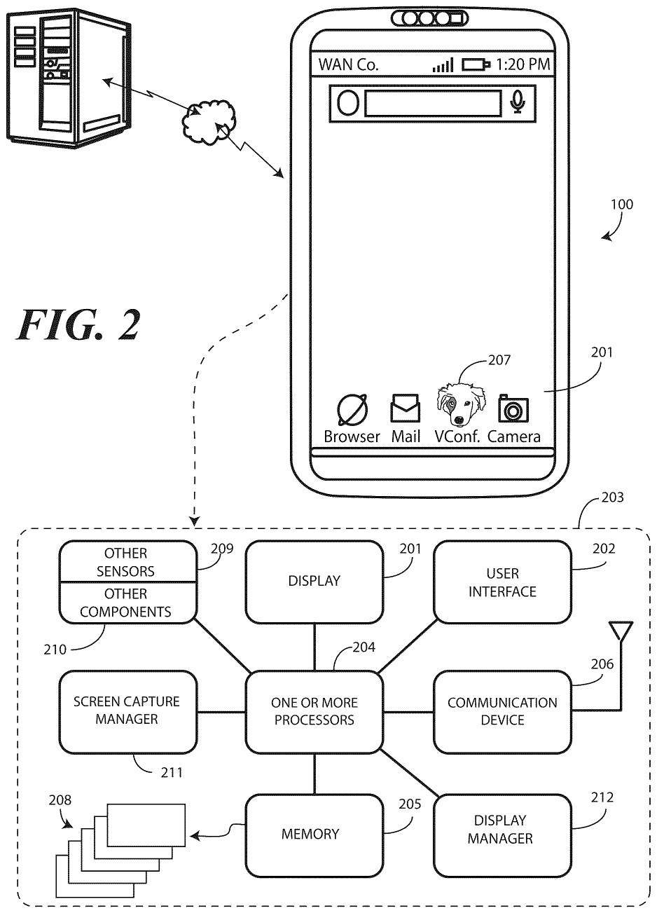

Turning now to FIG. 2, illustrated therein is an explanatory electronic device 100 configured in accordance with one or more embodiments of the disclosure. The electronic device 100 of FIG. 2 is a portable electronic device. For illustrative purposes, the electronic device 100 is shown as a smartphone.

However, the electronic device 100 could be any number of other devices as well, including tablet computers, desktop computers, notebook computers, and so forth. Still other types of conferencing system terminal devices can be configured in accordance with one or more embodiments of the disclosure as will be readily appreciated by those of ordinary skill in the art having the benefit of this disclosure.

This illustrative electronic device 100 includes a display 201, which may optionally be touch sensitive. In one embodiment where the display 201 is touch sensitive, the display 201 can serve as a primary user interface 202 of the electronic device 100. Users can deliver user input to the display 201 of such an embodiment by delivering touch input from a finger, stylus, or other objects disposed proximately with the display 201.

In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure. Where the electronic device 100 is configured with a keyboard and/or mouse, such as when the electronic device 100 is configured as a computer, the keyboard and/or mouse can serve as the primary user interface 202.

A block diagram schematic 203 of the electronic device 100 is also shown in FIG. 2. The block diagram schematic 203 can be configured as a printed circuit board assembly disposed within the device housing of the electronic device 100. Various components can be electrically coupled together by conductors or a bus disposed along one or more printed circuit boards.

In one or more embodiments, the electronic device 100 includes one or more processors 204. In one embodiment, the one or more processors 204 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 205, can optionally store the executable software code used by the one or more processors 204 during operation.

The electronic device 100 also includes a communication device 206 that can be configured for wired or wireless communication with one or more other devices or networks. The networks can include a wide area network, a local area network, and/or personal area network. The communication device 206 may also utilize wireless technology for communication, such as, but are not limited to, peer-to-peer or ad hoc communications such as HomeRF, Bluetooth and IEEE 802.11, and other forms of wireless communication such as infrared technology. The communication device 206 can include wireless communication circuitry, one of a receiver, a transmitter, or transceiver, and one or more antennas.

In one embodiment, the one or more processors 204 can be responsible for performing the primary functions of the electronic device 100. For example, in one embodiment the one or more processors 204 comprise one or more circuits operable with one or more user interface devices, which can include the display 201, to engage in videoconferences by transmitting, receiving, and presenting images, video, content, or other presentation information. The executable software code used by the one or more processors 204, including that associated with a videoconference application 207, can be configured as one or more modules 208 that are operable with the one or more processors 204. Such modules 208 can store instructions, control algorithms, logic steps, and so forth.

In one embodiment, the one or more processors 204 are responsible for running the operating system environment of the electronic device 100. The operating system environment can include a kernel and one or more drivers, and an application service layer, and an application layer. The operating system environment can be configured as executable code operating on one or more processors or control circuits of the electronic device 100.

The application layer can be responsible for executing application service modules. The application service modules may support one or more applications or “apps,” such as the videoconference application 207. The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 204 may generate commands or execute control operations based upon user input received at the user interface 202. Moreover, the one or more processors 204 may process the received information alone or in combination with other data, such as the information stored in the memory 205.

In one or more embodiments, the one or more processors 204 are operable with a display manager 212. In one or more embodiments, the display manager 212 of FIG. 2 can be queried to determine the type and relevancy of content being rendered on the display 201. This process can involve several approaches, each with the operational method and benefits.

Illustrating by example, in one or more embodiments the display manager 212 can analyze metadata associated with the content being rendered. Metadata includes information such as content type (e.g., video, image, text), source application, and content description. This approach allows for quick identification of content types without needing to process the actual content. The approach is efficient and can be implemented with minimal computational resources.

In other embodiments, applications rendering content can tag their output with specific identifiers that the display manager 212 can recognize. These tags can indicate whether the content is primary or secondary (e.g., PIP content). This method ensures accurate identification of content types as the tags are provided by the source applications. The method reduces the need for complex analysis by the display manager 212.

In still other embodiments, the display manager 212 can perform contextual analysis by examining the relationship between different content elements on the display. This involves analyzing the spatial arrangement, content overlap, and interaction patterns. Contextual analysis helps in understanding the importance of content based on the position and interaction with other content. Contextual analysis provides a dynamic and adaptive way to determine relevancy.

In still other embodiments, the display manager 212 can monitor user interactions with the content, such as clicks, touches, and focus changes. Content that receives more user interaction can be deemed more relevant. This approach leverages real-time user behavior to assess content relevancy. This method ensures that the most interacted-with content is prioritized, enhancing user experience.

In some embodiments, the display manager 212 can employ AI and machine learning (ML) algorithms to analyze content and predict relevancy based on learned patterns. These algorithms can be trained on large datasets to recognize common relevancy indicators. AI and ML provide a sophisticated and scalable way to determine content relevancy. They can adapt to new content types and user behaviors over time, improving accuracy and efficiency.

Of course, these approaches can be combined as will be obvious to those of ordinary skill in the art having the benefit of this disclosure. Illustrating by example, the display manager 212 can combine metadata analysis, content tagging, contextual analysis, user interaction monitoring, and AI/ML to create a comprehensive relevancy determination system.

A hybrid approach leverages the strengths of multiple methods, providing a robust and reliable way to identify and prioritize content. The hybrid approach ensures that the system can handle various scenarios and content types effectively. By querying the display manager 212 using these approaches, the electronic device can accurately determine the type and relevancy of content being rendered on the display 201. This enables the device to manage screenshots and screen recordings more effectively, ensuring that only the intended content is captured and shared.

In one or more embodiments, the screenshot capture manager 211 of FIG. 2 is a component within the electronic device 100 responsible for managing the process of capturing screenshots. In one or more embodiments, this manager works in conjunction with other components of the device, such as the user interface 202 and one or more processors 204, to ensure that screenshots are captured according to specific criteria and settings. Here is a simplified explanation of how the screenshot capture manager 211 captures screenshots in one or more embodiments.

In one or more embodiments, the process begins when the user provides input through the user interface to initiate a screenshot operation. This input could be a button press, a gesture, or a command. Once the screenshot operation is initiated, the screenshot capture manager 211 queries the display manager 212 to analyze the content being displayed on the display 201. In one or more embodiments, this analysis involves identifying the types of content present, such as the primary visual content and any overlay content like picture-in-picture (PIP) windows.

In one or more embodiments. the screenshot capture manager 211, in conjunction with the one or more processors 204, determines the relevancy of the PIP content to the primary visual content. In one or more embodiments, this step involves assessing whether the PIP content is related to or necessary for the primary content being captured.

In one or more embodiments, if the PIP content is deemed irrelevant, the screenshot capture manager 211 precludes this content from the screenshot. This means that the PIP content will not appear in the final captured image. Instead, the screenshot capture manager 211 ensures that the screenshot only includes the primary visual content, maintaining clarity and focus.

After precluding the irrelevant PIP content, the screenshot capture manager 211 can capture the screenshot of the remaining visual content. The captured screenshot is then stored in the device's memory or made available for sharing as per the user's requirements. By following these steps, the screenshot capture manager 211 ensures that the screenshots captured by the electronic device are free from unwanted overlay content, thereby addressing privacy concerns and enhancing the overall user experience.

In one or more embodiments, the screenshot capture manager 211 and display manager 212 are operable with the one or more processors 204. In some embodiments, the one or more processors 204 can control the screenshot capture manager 211 and display manager 212.

In other embodiments, screenshot capture manager 211 and display manager 212 can operate independently. The screenshot capture manager 211 and display manager 212 can receive data from the various sensors 209. In one or more embodiments, the one or more processors 204 are configured to perform the operations of the screenshot capture manager 211 and display manager 212.

Accordingly, in one or more embodiments the one or more processors 204 are configured to, in response to receipt of user input by the user interface 202 initiating a screenshot operation while visual content is being presented on the user interface 202 with picture-in-picture content overlayed atop the visual content, preclude depiction of the picture-in-picture content in one or more screenshots resulting from the screenshot operation by instead depicting portions of the visual content beneath which the picture-in-picture content is overlayed at locations where the picture-in-picture content is overlayed. In one or more embodiments, the one or more processors 204 are further configured to omit audio content associated with the picture-in-picture content from inclusion with the one or more screenshots.

In some embodiments, the one or more processors 204 only preclude depiction of the picture-in-picture content in one or more screenshots when the picture-in-picture content is unrelated to the visual content. In some embodiments, the one or more processors 204 deem the picture-in-picture content to be unrelated to the visual content when other user input received by the user interface 202 defines a boundary around the picture-in-picture content.

In one or more embodiments, the visual content comprises a videoconference and the picture-in-picture content comprises a movie, as was the case above in FIG. 1. In one or more embodiments, the user interface 202 of FIG. 2 serves as the primary means for users to interact with the electronic device 100.

In one or more embodiments, the user interface 202 can include a display 201. Users can deliver user input to the display 201 by delivering touch input from a finger, stylus, or other objects disposed proximately with the display 201. The user interface 202 can also include other input devices such as a keyboard and/or mouse, especially when the electronic device 100 is configured as a computer.

In one or more embodiments, the user interface 202 is responsible for receiving user input initiating a screenshot operation while visual content is being presented on the display 201. The user interface 202 can also be responsible for presenting visual content on the display 201 of the electronic device 100.

In one or more embodiments, the user interface 202 presents picture-in-picture content atop the visual content. In one or more embodiments, the user interface 202 receives user input requesting screenshot capture of an area of the display 201 spanning both the visual content and the picture-in-picture content.

In one or more embodiments, the user interface 202 works in conjunction with the one or more processors 204 to preclude depictions of the picture-in-picture content from screenshots resulting from the screenshot capture when the picture-in-picture content is unrelated to the visual content. The determination of whether the picture-in-picture content is unrelated to the visual content can be based on various factors, including the presence of audio associated with the picture-in-picture content.

In one or more embodiments, if the picture-in-picture content has audio associated with the picture-in-picture content, the method deems the picture-in-picture content to be unrelated to the visual content. The user interface 202 and the one or more processors 204 ensure that the screenshot captures only the intended visual content, excluding any irrelevant picture-in-picture content that may overlay the primary content.

The electronic device 100 can include one or more sensors 209. The one or more sensors 209 may include a microphone, an earpiece speaker, and/or a second loudspeaker. The one or more other sensors 209 may also include touch actuator selection sensors, proximity sensors, a touch pad sensor, a touch screen sensor, a capacitive touch sensor, and one or more switches. Touch sensors may used to indicate whether any of the user actuation targets present on the display 201 are being actuated. The other sensors 209 can also include audio sensors and video sensors (such as a camera).

Other components 210 operable with the one or more processors 204 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 210 can also include an audio input/processor. The audio input/processor can include hardware, executable code, and speech monitor executable code in one embodiment. The audio input/processor can include, stored in memory 205, basic speech models, trained speech models, or other modules that are used by the audio input/processor to receive and identify voice commands that are received with audio input captured by an audio input/processor, one example of which is a microphone of the one or more sensors 209. In one embodiment, the audio input/processor can include a voice recognition engine. Regardless of the specific implementation utilized in the various embodiments, the audio input/processor can access various speech models to identify speech commands in one or more embodiments.

To capture video during a videoconference, in one or more embodiments the electronic device 100 includes an image capture device. The electronic device 100 can optionally include a depth imager as well.

In one embodiment, the image capture device comprises a two-dimensional imager configured to receive at least one image of a person within an environment of the electronic device 100. In one embodiment, the image capture device comprises a two-dimensional RGB imager. In another embodiment, the image capture device comprises an infrared imager. Other types of imagers suitable for use as the image capture device of the electronic device 100 will be obvious to those of ordinary skill in the art having the benefit of this disclosure.

In one or more embodiments, the electronic device 100 includes a companion device display integration manager. The companion device display integration manager can be used to communicate with a companion electronic device. The electronic device 100 can operate as a stand-alone electronic device in one or more embodiments. However, in other embodiments, the electronic device 100 can operate in tandem with a content presentation companion device and/or augmented reality companion device via wireless electronic communication using the communication device 206.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices configured in accordance with embodiments of the disclosure may include various other components not shown in FIG. 2 or may include a combination of two or more components or a division of a particular component into two or more separate components, and still be within the scope of the present disclosure.

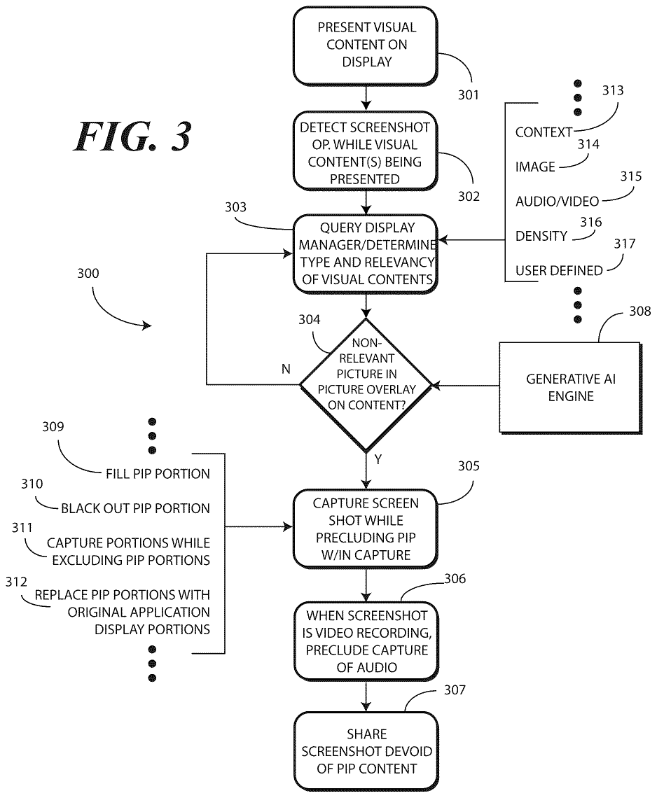

Turning now to FIG. 3, illustrated therein is one explanatory method 300 for an electronic device, one example of which is the electronic device (100) of FIGS. 1 and 2. The method 300 of FIG. 3 begins at step 301 where content is presented on the display of an electronic device. In some embodiments, the content comprises picture-in-picture (PIP) content. Said differently, in one or more embodiments step 301 comprises presenting, by a user interface, visual content on a display of the electronic device and also presenting, by the user interface, picture-in-picture content atop the visual content.

PIP content allows users to view a smaller window of secondary content overlayed atop the primary content displayed on the device. This feature enables multitasking by allowing users to keep an eye on secondary content while engaging with the primary content.

Several examples of PIP content include video playback, video calls, and live streaming. For instance, a user may watch a video in a PIP window while browsing the internet or working on a document in the primary content area. Similarly, a video call can be displayed in a PIP window, allowing the user to continue with other tasks on the device without losing sight of the call. Live streaming of events or news can also be presented in a PIP window, enabling the user to stay updated while performing other activities.

The arrangement of PIP content on the display can vary based on user preferences and the device's capabilities. Illustrating by example, in one or more embodiments the visual content comprises at least first content portions overlayed atop at least second content portions. In some embodiments, the other portions of the visual content that are considered for relevancy with the picture-in-picture content exclude the picture-in-picture content.

In one arrangement, the PIP window can be positioned at one of the corners of the display, such as the top-right or bottom-left corner, ensuring minimal obstruction of the primary content. Another arrangement allows the PIP window to be movable, enabling the user to drag and position the window anywhere on the display. Additionally, the size of the PIP window can be adjustable, allowing the user to resize the window to suit their needs. These flexible arrangements ensure that the PIP content enhances the user experience without significantly interfering with the primary content displayed on the electronic device

At step 302, the method 300 receives, by a user interface of the electronic device, user input initiating a screenshot operation. In one or more embodiments. This user input is received while visual content is being presented on the user interface as a result of the operation of step 301. In one or more embodiments, step 302 comprises receiving, by the user interface, user input requesting screenshot capture of an area of the display spanning both the visual content and the picture-in-picture content.

In one or more embodiments step 303 comprises determining, by one or more processors operable with the user interface, whether the picture-in-picture content is being presented with the visual content. Illustrating by example, step 303 can comprise determining whether the picture-in-picture content is overlapping or partially overlapping the content of a foreground application actively in operation on the one or more processors.

Step 303 can also comprise, where the picture-in-picture content is being presented with the visual content, determining, by the one or more processors, whether the picture-in-picture content is relevant to other portions of the visual content. This can occur in a variety of ways.

Context 313 of content being presented on a display can be used to determine whether the picture-in-picture content is relevant to other portions of the visual content. In one or more embodiments, this comprises the process of analyzing the content being displayed on an electronic device to decide if the picture-in-picture (PIP) content is related to the main content.

The method 300 can use various methods to understand the context 313 of the content being displayed. In one or more embodiments, this involves examining the type of content, the source of the content, and how the content relates to the primary content on the screen.

In one or more embodiments, the method 300 identifies different types of content on the screen, such as text, images 314, videos 315 and/or audio, or applications. For example, in one or more embodiments step 303 distinguishes between a video call in a PIP window and a document being edited in the main window. In other embodiments, the picture-in-picture content is deemed to be unrelated to the visual content when the picture-in-picture content has audio associated therewith.

Using context 313, if the main content is a business presentation and the PIP content is a video call related to the presentation, the PIP content might be considered relevant. If the PIP content is an unrelated movie, the PIP content would be deemed irrelevant.

The device can monitor user interactions 317, such as clicks or touches, to determine which content the user is actively engaging with. More interaction with the main content suggests that the PIP content is less relevant.

User interactions 317 can determine relevancy in other ways as well. Illustrating by example, in other embodiments the user interface can receive user input defining a boundary around the picture-in-picture content, thereby identifying the content within the boundary as being non-relevant so that step 305 can preclude the depiction of the picture-in-picture content by precluding the depiction of all top level content within the boundary. Where the picture-in-picture content comprises first picture-in-picture content and second picture-in-picture content, in one or more embodiments the boundary is situated only about the first picture-in-picture content.

Advanced methods may involve using a generative AI engine 308 and machine learning algorithms that analyze patterns and predict relevancy based on learned data. These algorithms can adapt to new types of content and user behaviors over time, improving accuracy.

In other embodiments, applications can tag their content with metadata indicating the type and importance. Step 303 can use these tags to quickly identify and assess the relevance of the PIP content. By using these methods, decision 304, optionally with the assistance of the generative AI engine 308, can decide whether the PIP content is included in the screenshot or screen recording.

If the PIP content is deemed irrelevant, step 305 will exclude the PIP content, ensuring that only the primary, relevant content is captured. In one or more embodiments, step 305 further comprises precluding audio associated with the picture-in-picture content from being included with the video recording.

In one or more embodiments, step 305 comprises, where the picture-in-picture content is irrelevant to the other portions of the visual content, precluding, by the one or more processors, depiction of the picture-in-picture content from a screenshot resulting from the screenshot operation. In other embodiments, step 305 comprises precluding, by one or more processors operable with the user interface, depictions of the picture-in-picture content from screenshots resulting from the screenshot capture when the picture-in-picture content is unrelated to the visual content. This process helps maintain the clarity and focus of the captured content and addresses privacy concerns by preventing the unintended sharing of irrelevant or sensitive information.

Step 305 can occur in a variety of ways. In one or more embodiments, the precluding the depictions of the picture-in-picture content comprises replacing 309 the picture-in-picture content with portions of the visual content over which the picture-in-picture content is positioned. In other embodiments, step 305 comprises precluding the depiction of the picture-in-picture content by removing the picture-in-picture content from the screenshot.

In still other embodiments, step 305 comprises obfuscating 310 the picture-in-picture content within the screenshot. In one or more embodiments, step 305 of FIG. 3 can obfuscate 310 the picture-in-picture (PIP) content by applying various techniques to ensure that the PIP content is not discernible in the resulting screenshot.

One method involves pixelation, where the PIP content is transformed into a grid of large, indistinct pixels, rendering the original content unrecognizable. This technique effectively masks the details of the PIP content while maintaining the overall structure of the image, ensuring that the primary visual content remains clear and focused.

Another approach to obfuscation 310 involves blurring the PIP content. In this method, the PIP content is subjected to a Gaussian blur or similar algorithm, which smooths out the details and edges, creating a hazy, indistinct area within the screenshot. This blurring effect ensures that the PIP content cannot be easily identified or interpreted, thereby protecting any sensitive or irrelevant information that may be present in the PIP window.

In some embodiments, step 305 can replace the PIP content with a solid color or pattern. This method involves filling the area occupied by the PIP window with a uniform color, such as black or gray, or a repetitive pattern, such as stripes or dots. This technique effectively removes any visual information from the PIP content, ensuring that the primary content remains the focus of the screenshot. The use of a solid color or pattern also provides a clear visual indication that the PIP content has been intentionally obfuscated.

Additionally, step 305 can employ content-aware fill techniques to obfuscate the PIP content. In this method, the area occupied by the PIP window is filled with content that matches the surrounding visual elements. This approach uses advanced algorithms to analyze the primary content and generate a seamless fill that blends with the rest of the image. By doing so, the PIP content is effectively hidden, and the screenshot appears as if the PIP window was not present, maintaining the integrity and clarity of the primary visual content. These obfuscation 310 techniques can be implemented individually or in combination, depending on the specific requirements and preferences of the user. By providing multiple methods for obfuscating PIP content, step 305 ensures that users have the flexibility to choose the most appropriate technique for their needs, enhancing privacy and improving the overall user experience.

In other embodiments, the precluding the depiction of the picture-in-picture content at step 305 comprises omitting 311 screenshot capture of the picture-in-picture content. In still other embodiments, the precluding the depiction of the picture-in-picture content at step 305 comprises replacing 312 the picture-in-picture content with other content atop which the picture-in-picture content is overlayed.

In one or more embodiments, the precluding the depiction of the picture-in-picture content at step 305 occurs only when the picture-in-picture content has audio content associated therewith. Regardless of whether audio is used as a criterion for relevancy, where step 305 precludes the capture if picture-in-picture content, step 306 can preclude the capture of audio content as well. Step 307 can the share the screenshot devoid of the picture-in-picture content using a communication device.

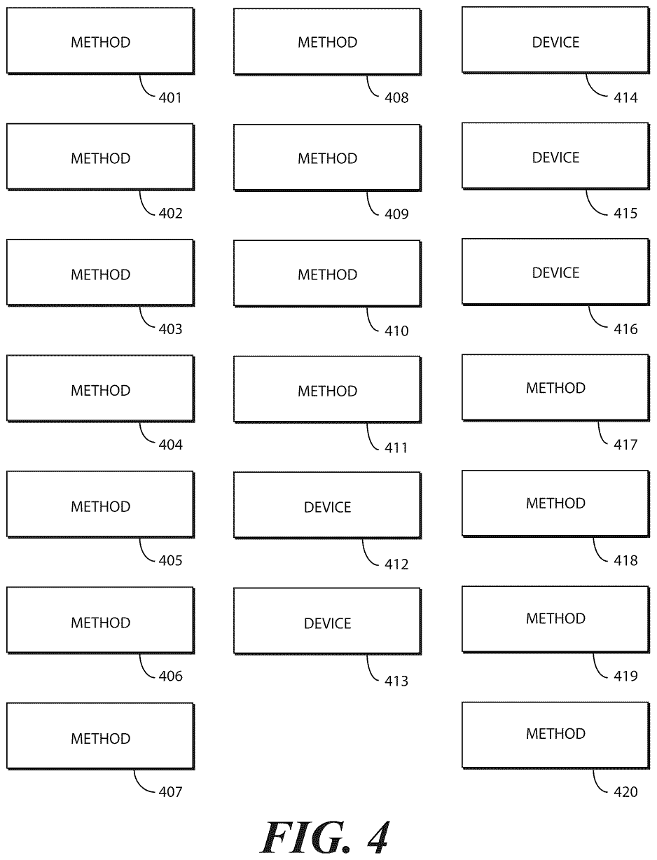

Turning now to FIG. 4, illustrated therein are various embodiments of the disclosure. The embodiments of FIG. 4 are shown as labeled boxes in FIG. 4 due to the fact that the individual components of these embodiments have been illustrated in detail in FIGS. 1-3, which precede FIG. 4. Accordingly, since these items have previously been illustrated and described, their repeated illustration is no longer essential for a proper understanding of these embodiments. Thus, the embodiments are shown as labeled boxes.

At 401, a method in an electronic device comprises receiving, by a user interface while visual content is being presented the user interface, user input initiating a screenshot operation. At 401, the method comprises determining, by one or more processors operable with the user interface, whether picture-in-picture content is being presented with the visual content.

At 401, the method comprises, where the picture-in-picture content is being presented with the visual content, determining, by the one or more processors, whether the picture-in-picture content is relevant to other portions of the visual content. At 401, the method comprises, where the picture-in-picture content is irrelevant to the other portions of the visual content, precluding, by the one or more processors, depiction of the picture-in-picture content from a screenshot resulting from the screenshot operation.

At 401, the other portions of the visual content of 401 exclude the picture-in-picture content. At 403, the screenshot of 401 comprises a video recording. At 404, the method of 403 further comprises precluding audio associated with the picture-in-picture content from being included with the video recording.

At 405, the precluding the depiction of the picture-in-picture content of 401 comprises removing the picture-in-picture content from the screenshot. At 406, the precluding the depiction of the picture-in-picture content of 401 comprises obfuscating the picture-in-picture content within the screenshot.

At 407, the precluding the depiction of the picture-in-picture content of 401 comprises replacing the picture-in-picture content with other content atop which the picture-in-picture content is overlayed. At 408, the precluding the depiction of the picture-in-picture content of 401 comprises omitting screenshot capture of the picture-in-picture content. At 409, the precluding the depiction of the picture-in-picture content of 401 occurs only when the picture-in-picture content has audio content associated therewith.

At 410, the method of 401 further comprises receiving, by the user interface, other user input defining a boundary around the picture-in-picture content. At 410, the precluding the depiction of the picture-in-picture content comprises precluding the depiction of all top level content within the boundary.

At 411, the picture-in-picture content of 410 comprises first picture-in-picture content and second picture-in-picture content. At 411, the boundary is situated only about the first picture-in-picture content.

At 412, an electronic device comprises a user interface and one or more processors operable with the user interface. At 412, the one or more processors are configured to, in response to receipt of user input by the user interface initiating a screenshot operation while visual content is being presented on the user interface with picture-in-picture content overlayed atop the visual content, preclude depiction of the picture-in-picture content in one or more screenshots resulting from the screenshot operation by instead depicting portions of the visual content beneath which the picture-in-picture content is overlayed at locations where the picture-in-picture content is overlayed.

At 413, the electronic device of 412 the one or more processors are further configured to omit audio content associated with the picture-in-picture content from inclusion with the one or more screenshots. At 414, the one or more processors of 412 only preclude depiction of the picture-in-picture content in one or more screenshots when the picture-in-picture content is unrelated to the visual content.

At 415, the one or more processors of 414 deem the picture-in-picture content to be unrelated to the visual content when other user input received by the user interface defines a boundary around the picture-in-picture content. At 416, the visual content of 412 comprises a videoconference and the picture-in-picture content comprising a movie.

At 417, a method in an electronic device comprises presenting, by a user interface, visual content on a display of the electronic device. At 417, the method comprises also presenting, by the user interface, picture-in-picture content atop the visual content.

At 417, the method comprises receiving, by the user interface, user input requesting screenshot capture of an area of the display spanning both the visual content and the picture-in-picture content. At 417, the method comprises precluding, by one or more processors operable with the user interface, depictions of the picture-in-picture content from screenshots resulting from the screenshot capture when the picture-in-picture content is unrelated to the visual content.

At 418, the picture-in-picture content of 417 is unrelated to the visual content when the picture-in-picture content has audio associated therewith. At 419, the method of 417 comprises replacing the picture-in-picture content with portions of the visual content over which the picture-in-picture content is positioned. At 420, the visual content of 417 comprises at least first content portions overlayed atop at least second content portions.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment an electronic device is configured to determine the relevance of picture-in-picture (PIP) content by analyzing metadata associated with the visual content being displayed. This metadata can include information such as content type, source application, and content description, allowing the device to quickly identify and assess the relevance of the PIP content without processing the actual content. This approach is efficient and requires minimal computational resources, making the approach suitable for devices with limited processing power.

In another embodiment, the electronic device employs a contextual analysis method to determine the relevance of PIP content. This involves examining the spatial arrangement, content overlap, and interaction patterns between the PIP content and the primary visual content. By understanding the importance of content based on the position and interaction with other content, the device can dynamically and adaptively determine the relevance of the PIP content. This method is particularly useful in scenarios where the relevance of content can change based on user interactions and the overall context of the displayed content.

In a further embodiment, the electronic device utilizes user interaction data to assess the relevance of PIP content. The device monitors user interactions such as clicks, touches, and focus changes to determine which content the user is actively engaging with. Content that receives more user interaction is deemed more relevant, and the device can prioritize this content in the screenshot capture process. This approach leverages real-time user behavior to make relevancy determinations, ensuring that the most interacted-with content is captured in the screenshot.

In yet another embodiment, the electronic device incorporates artificial intelligence (AI) and machine learning (ML) algorithms to analyze content and predict relevancy based on learned patterns. These algorithms can be trained on large datasets to recognize common relevancy indicators, allowing the device to adapt to new content types and user behaviors over time. This sophisticated and scalable method improves the accuracy and efficiency of relevancy determinations, providing a robust solution for managing screenshots and screen recordings.

In an additional embodiment, the electronic device allows users to manually define the relevance of PIP content by drawing a boundary around the PIP window. This user-defined boundary indicates that the content within the boundary is non-relevant, and the device precludes the depiction of all top-level content within the boundary from the screenshot. This method provides users with the flexibility to customize their screenshot capture preferences, ensuring that only the desired content is included in the screenshot.

In a further embodiment, the electronic device can preclude the depiction of PIP content by replacing the PIP window with portions of the primary visual content over which the PIP content is positioned. This ensures that the screenshot appears as if the PIP window was not present, maintaining the integrity and clarity of the primary visual content. This method is particularly useful in professional settings where users need to share screenshots without revealing unrelated or private content.

In another embodiment, the electronic device can obfuscate the PIP content within the screenshot by applying techniques such as pixelation, blurring, or replacing the PIP window with a solid color or pattern. These obfuscation methods ensure that the PIP content is not discernible in the resulting screenshot, protecting any sensitive or irrelevant information that may be present in the PIP window. This approach enhances privacy and improves the overall user experience by providing a clear and focused screenshot.

In still another embodiment, the electronic device can preclude the depiction of PIP content only when the PIP content has audio associated with the PIP content. This ensures that the screenshot captures only the intended visual content, excluding any irrelevant PIP content that may overlay the primary content. This method is useful in scenarios where the presence of audio indicates that the PIP content is unrelated to the primary visual content, such as when a user is watching a video in a PIP window while working on a document.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a user interface while visual content is being presented the user interface, user input initiating a screenshot operation;
determining, by one or more processors operable with the user interface, whether picture-in-picture content is being presented with the visual content;
where the picture-in-picture content is being presented with the visual content, determining, by the one or more processors, whether the picture-in-picture content is relevant to other portions of the visual content; and
where the picture-in-picture content is irrelevant to the other portions of the visual content, precluding, by the one or more processors, depiction of the picture-in-picture content from a screenshot resulting from the screenshot operation.

2. The method of claim 1, wherein the other portions of the visual content exclude the picture-in-picture content.

3. The method of claim 1, wherein the screenshot comprises a video recording.

4. The method of claim 3, further comprising precluding audio associated with the picture-in-picture content from being included with the video recording.

5. The method of claim 1, wherein the precluding the depiction of the picture-in-picture content comprises removing the picture-in-picture content from the screenshot.

6. The method of claim 1, wherein the precluding the depiction of the picture-in-picture content comprises obfuscating the picture-in-picture content within the screenshot.

7. The method of claim 1, wherein the precluding the depiction of the picture-in-picture content comprises replacing the picture-in-picture content with other content atop which the picture-in-picture content is overlayed.

8. The method of claim 1, wherein the precluding the depiction of the picture-in-picture content comprises omitting screenshot capture of the picture-in-picture content.

9. The method of claim 1, wherein the precluding the depiction of the picture-in-picture content occurs only when the picture-in-picture content has audio content associated therewith.

10. The method of claim 1, further comprising receiving, by the user interface, other user input defining a boundary around the picture-in-picture content, wherein the precluding the depiction of the picture-in-picture content comprises precluding the depiction of all top level content within the boundary.

11. The method of claim 10, wherein the picture-in-picture content comprises first picture-in-picture content and second picture-in-picture content, wherein the boundary is situated only about the first picture-in-picture content.

12. An electronic device, comprising:
a user interface; and
one or more processors operable with the user interface;
wherein the one or more processors are configured to, in response to receipt of user input by the user interface initiating a screenshot operation while visual content is being presented on the user interface with picture-in-picture content overlayed atop the visual content, preclude depiction of the picture-in-picture content in one or more screenshots resulting from the screenshot operation by instead depicting portions of the visual content beneath which the picture-in-picture content is overlayed at locations where the picture-in-picture content is overlayed.

13. The electronic device of claim 12, wherein the one or more processors are further configured to omit audio content associated with the picture-in-picture content from inclusion with the one or more screenshots.

14. The electronic device of claim 12, wherein the one or more processors only preclude depiction of the picture-in-picture content in one or more screenshots when the picture-in-picture content is unrelated to the visual content.

15. The electronic device of claim 14, wherein the one or more processors deem the picture-in-picture content to be unrelated to the visual content when other user input received by the user interface defines a boundary around the picture-in-picture content.

16. The electronic device of claim 12, wherein the visual content comprises a videoconference and the picture-in-picture content comprises a movie.

17. A method in an electronic device, the method comprising:
presenting, by a user interface, visual content on a display of the electronic device;
also presenting, by the user interface, picture-in-picture content atop the visual content;
receiving, by the user interface, user input requesting screenshot capture of an area of the display spanning both the visual content and the picture-in-picture content; and
precluding, by one or more processors operable with the user interface, depictions of the picture-in-picture content from screenshots resulting from the screenshot capture when the picture-in-picture content is unrelated to the visual content.

18. The method of claim 17, wherein the picture-in-picture content is unrelated to the visual content when the picture-in-picture content has audio associated therewith.

19. The method of claim 17, wherein the precluding the depictions of the picture-in-picture content comprises replacing the picture-in-picture content with portions of the visual content over which the picture-in-picture content is positioned.

20. The method of claim 17, wherein the visual content comprises at least first content portions overlayed atop at least second content portions.
